(19) United States
(12) Patent Application Publication
(10) Pub. No.: US 2014/0054986 A1
(43) Pub. Date: Feb. 27, 2014

(54) CONTROL APPARATUS FOR ROTARY ELECTRIC MACHINE, ROTARY ELECTRIC MACHINE DRIVE SYSTEM, AND CONTROL METHOD FOR ROTARY ELECTRIC MACHINE

(71) Applicants: Yu HIRAI, Toyota-shi (JP); Kazuhide MIYATA, Toyota-shi (JP)

(72) Inventors: Yu HIRAI, Toyota-shi (JP); Kazuhide MIYATA, Toyota-shi (JP)

(73) Assignee: TOYOTA JIDOSHA KABUSHIKI KAISHA, Toyota-shi (JP)

(21) Appl. No.: 13/960,374

(22) Filed: Aug. 6, 2013

(30) Foreign Application Priority Data
Aug. 27, 2012 (JP) 2012-186527

(51) Int. Cl. H02K 9/19

(52) U.S. Cl. CPC H02K 9/19
USPC 310/53

(57) ABSTRACT

A control apparatus for a rotary electric machine, which has a rotary element that includes a permanent magnet, includes a magnet temperature acquisition portion, a coolant temperature detection portion and a temperature control portion. The magnet temperature acquisition portion acquires information about temperature of the permanent magnet. The coolant temperature detection portion detects temperature of a coolant that cools at least the rotary element. The temperature control portion performs a temperature raising control of the permanent magnet when the temperature of the permanent magnet is less than or equal to a first threshold temperature and the temperature of the coolant is less than or equal to a second threshold temperature.

INCORPORATION BY REFERENCE

The disclosure of Japanese Patent Application No. 2012-186527 filed on Aug. 27, 2012 including the specification, drawings and abstract is incorporated herein by reference in its entirety.

### BACKGROUND OF THE INVENTION

1. Field of the Invention

The invention relates to a control apparatus for a rotary electric machine, a rotary electric machine drive system, and a control method for a rotary electric machine.

2. Description of Related Art

In rotary electric machines that use permanent magnets, there is a problem of demagnetization of permanent magnets dependent on change in temperature. For example, Japanese Patent Application Publication No. 2009-171640 (JP 2009-171640 A) discloses a drive control apparatus for an electric motor which estimates the temperature of the permanent magnets attached to the rotary element from the oil temperature or the stator temperature and then changes the ranges of application of drive control modes on the basis of the estimated temperature of the permanent magnets. In JP 2009-171640 A, when the magnet temperature rises, a motor operation region in which a square wave control mode is applied is set wider than a motor operation region in which a PWM control is applied. In the square wave control mode, the magnetic field fluctuation caused by a high-frequency component of motor current is less, and therefore eddy current is less. In the PWM control, switching control at high frequency is performed.

Japanese Patent Application Publication No. 2003-235286 (JP 2003-235286 A) points out that when a control apparatus for a synchronous rotary electric machine estimates the temperature of the permanent magnets from the armature magnetic flux in the circuit equations for vector control, the estimation is affected by the temperature dependency of coil resistance and the d-axis current dependency of d-axis inductance, etc. JP 2003-235286 A discloses that it becomes possible to estimate the temperature of the permanent magnets, without influence of the aforementioned factors, by using a harmonic voltage command value together with the fundamental current and the rotation speed of the synchronous rotary electric machine.

Furthermore, Japanese Patent Application Publication No. 2010-93982 (JP 2010-93982 A) states, regarding a motor drive apparatus, that when the temperature of the permanent magnets detected by a temperature sensor or the like exceeds a threshold value, the carrier frequency for switching the switching element is increased so as to reduce the ripple current superimposed on the motor current.

Conversely, Japanese Patent Application Publication No. 2009-189181 (JP 2009-189181 A) states, regarding a motor drive control method, that the magnet temperature is estimated from a value of the motor current, and that when the magnet temperature is lower than a reference temperature, the carrier frequency is made lower than usual one so as to increase the ripple current and therefore increase the eddy current, so that the motor temperature will rise.

The temperature of a rotary electric machine rises due to its operation. Therefore, cooling the rotary electric machine is performed in order to prevent demagnetization of the permanent magnets. Lowering the temperature of the coolant for cooling the machine is effective in preventing the demagnetization of the permanent magnets. On the other hand, lowering the temperature of the coolant causes an increase of viscosity of the coolant. As a result of the increase of viscosity, rotation load of the rotary electric machine is increased and therefore energy efficiency is decreased. Hence, good balance between prevention of demagnetization and improvement of energy efficiency is desired.

### SUMMARY OF THE INVENTION

The invention provides a control apparatus for a rotary electric machine, a rotary electric machine drive system, and a control method for a rotary electric machine in which it is possible to improve energy efficiency while preventing demagnetization of the permanent magnets.

A control apparatus for a rotary electric machine in accordance with a first aspect of the invention is a control apparatus for a rotary electric machine that has a rotary element that includes a permanent magnet. The control apparatus includes: a magnet temperature acquisition portion that acquires information about temperature of the permanent magnet; a coolant temperature detection portion that detects temperature of a coolant that cools at least the rotary element; and a temperature control portion. The temperature control portion performs a temperature raising control of the permanent magnet when the temperature of the permanent magnet is less than or equal to a first threshold temperature and the temperature of the coolant is less than or equal to a second threshold temperature.

According to the foregoing construction, by setting the first threshold temperature to a temperature within a range in which demagnetization of the permanent magnet does not occur, it is possible to raise the temperature of the permanent magnet and therefore raise the temperature of the coolant within a temperature range in which there is substantially no possibility of demagnetization of the permanent magnet, so that the viscosity of the coolant correspondingly decreases and energy efficiency improves.

In the first aspect of the invention, system voltage of a drive circuit connected to the rotary electric machine may be increased in the temperature raising control. Also, a drive control mode of the rotary electric machine may be changed from a square wave control mode to a sine wave control mode in the temperature raising control.

According to the foregoing construction, at the sine wave control mode, the high-frequency component of the drive signal is greater and the magnetic field fluctuation of the stationary element is more frequent than at the square wave control mode. Therefore, the eddy current loss of the permanent magnet increases, so that the permanent magnet rises in temperature and therefore the coolant, which cools the permanent magnet, rises in temperature. Due to this, the energy efficiency can be improved.

In the first aspect of the invention, an offset deviation may be provided between drive electric current values of phases of the rotary electric machine in the temperature raising control.

According to the foregoing construction, a rotary electric machine of, for example, a three-phase drive type, is controlled so that the sum of the values of the drive currents of the three phases becomes zero. However, if the offset deviation is provided between the values of the drive currents of the three phases, the sum of the values of the drive currents of the three phases does not become zero and a direct-current (DC) component current flows. As a result, the rotating permanent magnet undergoes an amount of magnetic field fluctuation that is commensurate with occurrence of the DC component current. Therefore, an eddy current occurs in the permanent magnet, the temperature of the permanent magnet rises and the temperature of the coolant which cools the permanent magnet rises. Thus, the energy efficiency can be improved.

In the first aspect of the invention, a carrier frequency that is used by a drive circuit connected to the rotary electric machine may be changed to a lower carrier frequency in the temperature raising control.

According to the foregoing construction, the ripple current that is superimposed on the drive current becomes larger since the carrier frequency is changed to a lower frequency. The increase in the ripple current increases the eddy current that occurs in the permanent magnet, so that the temperature of the permanent magnet rises and therefore the temperature of the coolant which cools the permanent magnet rises. Due to this, the energy efficiency can be improved.

In the first aspect of the invention, the temperature control portion performs the temperature raising control while maintaining an operation point of the rotary electric machine.

According to the foregoing construction, it is possible to quickly raise the temperatures of the permanent magnet and the coolant without changing the state of operation of the rotary electric machine.

A rotary electric machine drive system in accordance with a second aspect of the invention includes: a rotary electric machine that has a rotary element that includes a permanent magnet; a coolant temperature sensor that detects temperature of a coolant that flows in the rotary electric machine; a control circuit connected to the rotary electric machine; and a control apparatus that controls the control circuit. The control apparatus includes a magnet temperature acquisition portion that acquires information about temperature of the permanent magnet, a coolant temperature detection portion that detects the temperature of the coolant, and a temperature control portion. The temperature control portion performs a temperature raising control of the permanent magnet when the temperature of the permanent magnet is less than or equal to a first threshold temperature and the temperature of the coolant is less than or equal to a second threshold temperature.

A control method in accordance with a third aspect of the invention is a control method for a rotary electric machine that has a rotary element that includes a permanent magnet. The control method includes: acquiring information about temperature of the permanent magnet; detecting temperature of a coolant that cools the rotary element; and performing a temperature raising control of the permanent magnet when the temperature of the permanent magnet is less than or equal to a first threshold temperature and the temperature of the coolant is less than or equal to a second threshold temperature.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a drive system for a rotary electric machine which includes a control apparatus for the rotary electric machine in accordance with an embodiment of the invention;

FIG. 2 is a flowchart showing a procedure of a drive control of a rotary electric machine in an embodiment of the invention;

FIGS. 3A to 3C are diagrams showing estimation of the temperature of a permanent magnet without using a temperature sensor in an embodiment of the invention;

FIGS. 4A and 4B are diagrams showing the switching between control modes of a rotary electric machine by changing the system voltage in an embodiment of the invention;

FIGS. 5A to 5C are diagrams showing provision of an offset deviation among values of drive currents of different phases of the rotary electric machine in an embodiment of the invention; and

FIGS. 6A and 6B are diagrams showing that the magnitude of ripple current changes due to changes in the carrier frequency of an inverter in an embodiment of the invention.

### DETAILED DESCRIPTION OF EMBODIMENTS

Embodiments of the invention will be described in detail hereinafter with reference to the drawings. Although a motor-generator to be mounted in a vehicle will be described below as a rotary electric machine, the rotary electric machine in the invention may be a rotary electric machine that is not mounted in a vehicle. Furthermore, although neodymium magnets will be described as permanent magnets employed in the rotary electric machine below, the permanent magnets may also be other rare earth magnets, for example, samarium-cobalt base magnets, samarium-iron-nitrogen base magnets, etc. Furthermore, besides rare earth magnets, the permanent magnets may also be ferrite magnets or alnico magnets. Although in the following description, the coolant for cooling the rotor that includes permanent magnets is an automatic transmission fluid (ATF), the coolant may also be an oil coolant other than ATF, and may also be an aqueous coolant or a gaseous coolant.

Although the following description of the rotary electric machine will be made on the assumption that the control mode is switched between a square wave control mode and a sine wave control mode, the control mode may be switched between three modes that include an overmodulation control mode as well as the aforementioned two modes. In this case, if the system voltage is increased while the fundamental wave component of the output of the inverter is fixed, the control mode is switched, according to the increasing direction of the system voltage, from the square wave control mode to the overmodulation control mode and then from the overmodulation control mode to the sine wave modulation mode. Furthermore, the eddy current loss of the permanent magnets of the rotary element increases with the transition of the control mode from the square wave control mode to the sine wave control mode.

The temperature, the voltage, etc. mentioned below are mere examples, and may be changed as appropriate according to the specifications of the rotary electric machine control apparatus.

In the following description, like elements are denoted by like reference characters in the drawings, and redundant descriptions will be omitted. Furthermore, in the description, the reference characters mentioned before will be used according to need.

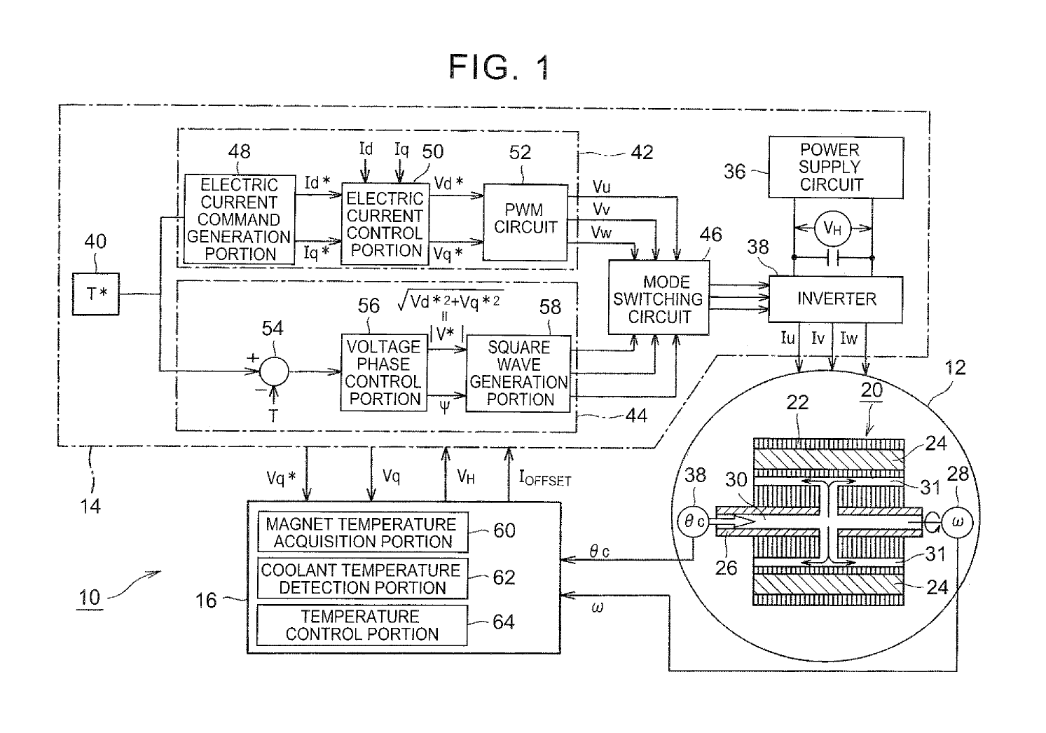

FIG. 1 is a diagram showing a construction of a rotary electric machine drive system 10 for a vehicle. The rotary electric machine drive system 10 includes a rotary electric machine 12 mounted in a vehicle, a control circuit 14 connected to the rotary electric machine 12, and a control apparatus 16 that controls the control circuit 14. It is to be noted herein that the control circuit 14 and the control apparatus 16 perform the function of controlling the operation of the rotary electric machine 12, and correspond to a drive control apparatus for a rotary electric machine..

The rotary electric machine 12 is a motor-generator mounted in a vehicle, and is a three-phase synchronous rotary electric machine. Specifically, the rotary electric machine 12 serves as an electric motor at the time of the power running of the vehicle, and serves as an electricity generator when the vehicle is braking.

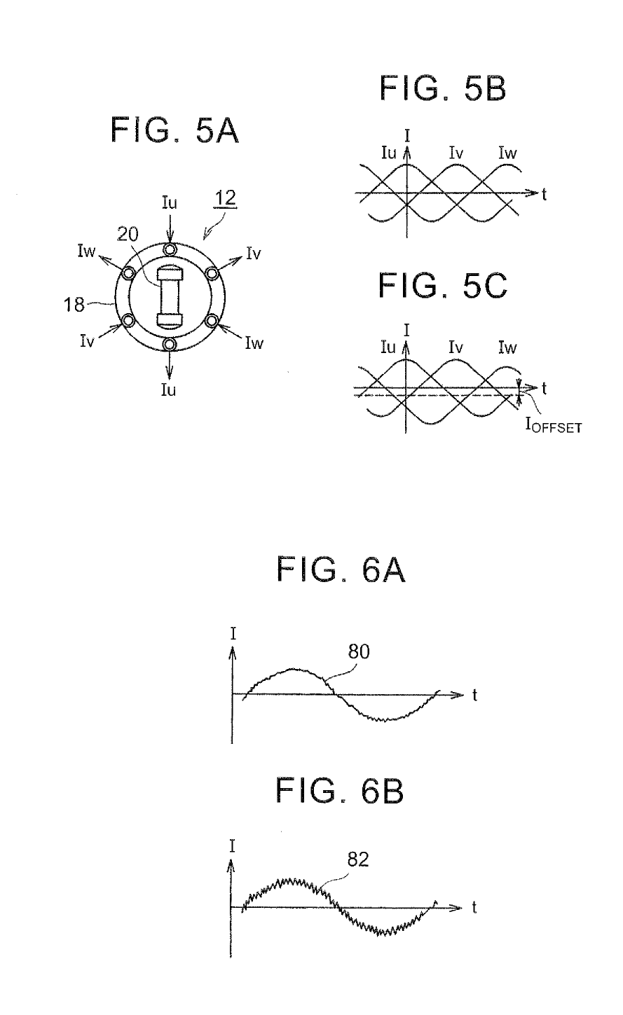

The rotary electric machine 12 includes a circular annular stationary element 18 and a rotary element 20. The circular annular stationary element 18 has winding wires of three phases that produce a rotating magnetic field. The rotary element 20 is disposed so as to be surrounded by the circular annular stationary element 18. Incidentally, the rotary element 20 is also referred to as the rotor. In FIG. 1, a portion of the rotary element 20 of the rotary electric machine 12 is isolated and shown in a sectional view. Incidentally, FIG. 5A described below shows a relationship between the stationary element 18 and the rotary element 20 in a schematic diagram of the rotary electric machine 12.

In the rotary element 20, a permanent magnet 24 is buried in a rotor core 22 formed by stacking electromagnetic steel sheets, and a rotation shaft 26 is attached along a center axis of the rotor core 22.

The permanent magnet 24 used in this example is a neodymium magnet that is a rare earth sintered magnet. The neodymium magnet has a temperature characteristic in which the magnetism decreases as the temperature increases. This temperature characteristic is a reversible demagnetization characteristic while the temperature is not very high. However, when the temperature becomes high, irreversible demagnetization of the neodymium magnet occurs depending on the strength of the demagnetizing field that the magnet is subjected to. As demagnetization of the permanent magnet 24 progresses, the output torque of the rotary electric machine 12 decreases. The temperature at which irreversible demagnetization occurs in a permanent magnet will be termed the demagnetization threshold temperature. The demagnetization threshold temperature of the permanent magnet 24 is, for example, 140° C. It is preferable that the permanent magnet 24 be used at or below the demagnetization threshold temperature.

The rotation shaft 26 is freely rotatably supported by bearings that are provided on a motor case (not shown). When the winding wires of the three phases of the stationary element are supplied with predetermined drive signals, the stationary element produces a rotating magnetic field, so that the rotary element 20 rotates and outputs torque to the rotation shaft 26 due to cooperative interaction of the rotating magnetic field and the permanent magnet 24.

A rotary angular velocity detection portion 28 is a device that detects the rotary angular velocity ω of the rotation shaft 26, and detection results are transferred to the control apparatus 16 by an appropriate signal line.

A coolant passageway 30 that extends through the rotation shaft 26 is a flow path through which a coolant for cooling the rotary element 20 flows. A coolant passageway 31 is a flow path that branches from the coolant passageway 30 and that extends in the rotor core 22 in a direction in which the permanent magnet 24 is disposed. The coolant that flows in the coolant passageways 30 and 31 is a fluid termed ATF. The ATF is an oil fluid that is circulated to a transmission (not shown in FIG. 1) for the lubricating and cooling purposes. The ATF has a temperature characteristic in which the viscosity increases as the temperature decreases. Since the ATE is used for lubrication of the rotary electric machine 12 and the transmission, an increase in the viscosity of the ATF results in an increase in the load on the rotary electric machine 12 and the transmission and therefore a decrease in the energy efficiency of the running of the vehicle. If the temperature at which there is no substantial effect of decrease in energy efficiency mentioned above is set as an energy efficiency threshold temperature, the energy efficiency threshold temperature is, for example, 50° C. It is preferable that the ATF be used at or above the energy efficiency threshold temperature.

The coolant temperature sensor 32 is a device that detects the temperature 0 c of the ATF, and detection results are transferred to the control apparatus 16 by an appropriate signal line.

The control circuit 14 includes a power supply circuit 36, an inverter 38 connected to the power supply circuit 36, a torque command portion 40 that gives a torque command value T*, a sine wave control circuit 42, a square wave control circuit 44 and a mode switching circuit 46.

The power supply circuit 36 is a high-voltage direct-current power supply that supplies direct-current electric power that has a system voltage V_{H} to the inverter 38. The power supply circuit 36 includes a power supply, such as an assembled lithium battery, an assembled nickel-metal-hydride battery, a large-capacity capacitor, etc., and an appropriate voltage step-up/step-down circuit. The system voltage V_{H} used herein is about 500 V to 600 V.

The inverter 38 is a circuit connected to the three-phase winding wires of the stationary element of the rotary electric machine 12, and includes a plurality of switching elements, reverse-connected diodes, etc., and performs the function of electric power conversion between direct-current electric power and alternating-current electric power. That is, the inverter 38 performs the DC-to-AC conversion function when the rotary electric machine 12 is caused to serve as an electric motor. When the DC-to-AC conversion function is performed, the direct-current electric power from the power supply circuit 36 side is converted into three-phase drive electric power and supplied as an alternating-current drive electric power to the rotary electric machine 12. Furthermore, when the rotary electric machine 12 is caused to serve as an electricity generator, the inverter 38 performs the AC-to-DC conversion function. When the AC-to-DC conversion function is performed, the three-phase regenerative electric power from the rotary electric machine 12 is converted into direct-current electric power and supplied as charging electric power to the power supply circuit 36 side.

The torque command portion 40 detects the accelerator operation performed by a driver who is a user of the vehicle, and gives the detected result, as a torque command value T* that the user demands, to the sine wave control circuit 42 and the square wave control circuit 44.

The sine wave control circuit 42 is a circuit that generates a PWM drive signal and supplies it to the inverter 38 when the control mode of the rotary electric machine 12 is the sine wave control mode. The sine wave control circuit 42 is a circuit that performs a current feedback control to feed back the actual value of electric current to the command value of electric current. The sine wave control circuit 42 includes an electric current command generation portion 48, an electric current control portion 50 and a PWM circuit 52.

The electric current command generation portion 48 receives the torque command value T*, and a d-axis electric current command value I_{d}* and a q-axis electric current command value I_{q}* for vector control. The electric current control portion 50 obtains a d-axis actual electric current value I_{d} and a q-axis actual electric current value I_{q} by converting actual values I_{U}, I_{V} and I_{W} of the three-phase drive currents of the rotary electric machine 12. Furthermore, the electric current control portion 50 executes a proportional integration (PI) control so that a d-axis electric current deviation ΔI_{d}=(I_{d}*−I_{d}) and a q-axis electric current deviation ΔI_{q}=(I_{q}*−I_{q}), which are obtained from the d-axis actual electric current value I_{d} and the q-axis actual electric current value I_{q}, are respectively set to zero, and outputs a d-axis voltage command value V_{d}* and a q-axis voltage command value V_{q}*. The PWM circuit 52 performs pulse conversion of the d-axis and q-axis voltage command values V_{d}* and V_{q}* and outputs the obtained three-phase drive voltage command values V_{U}, V_{V} and V_{W}.

The square wave control circuit 44 is a circuit that generates a square wave drive signal and supplies the signal to the inverter 38 when the control mode of the rotary electric machine 12 is the square wave control mode. The square wave control circuit 44 is a circuit that performs a torque feedback control to feed back the actual torque value T to the torque command value T*. The square wave control circuit 44 includes a subtracter 54, a voltage phase control portion 56 and a square wave generation portion 58.

The subtracter 54 obtains an actual torque value T of the rotary electric machine 12 from an actual value of the drive electric current, an actual value of the drive voltage and an actual rotation speed of the rotary electric machine 12, and outputs a torque deviation ΔT=(T*−T). The voltage phase control portion 56 outputs the absolute value of a command voltage vector |V*| and a command voltage phase Ψ so that the torque deviation is set to zero. It is to be noted herein that the absolute value of the command voltage vector is a value calculated as in |V*|=(V_{d}*²+V_{q}*²)^{1/2}. The square wave generation portion 58 outputs a square wave drive signal that has the absolute value of the command voltage vector |V*| and the command voltage phase Ψ.

The mode switching circuit 46 is a switching circuit that determines a control mode of the rotary electric machine 12 according to a predetermined switching reference, and connects the inverter 38 to either one of the PWM circuit 52 and the square wave generation portion 58 according to the determined control mode. The predetermined switching reference may be a modulation factor=V*|/V_{H}. For example, the sine wave control mode may be entered when the modulation factor is less than or equal to 0.61, and the square wave control mode may be entered when the modulation factor is greater than or equal to 0.78.

When the modulation factor is within the range of 0.61 to 0.78, the control mode of the rotary electric machine 12 may be set to the overmodulation control mode. In the case where the overmodulation control mode is employed, an overmodulation control circuit that supplies an overmodulation drive signal is provided in the control circuit 14. The overmodulation control circuit has substantially the same construction as the sine wave control circuit 42, except that the modulation factor applied in the PWM circuit 52 is within the range of 0.61 to 0.78, and therefore detailed description thereof is omitted.

The control apparatus 16 is an apparatus that controls the behaviors of the control circuit 14 as a whole. In the embodiment, the control apparatus 16 performs a control for improving the energy efficiency of the vehicle while restraining the demagnetization of the permanent magnet 24 by adjusting the balance between the temperature of the permanent magnet 24 and the temperature of the coolant.

The control apparatus 16 includes a magnet temperature acquisition portion 60 that acquires information about the temperature of the permanent magnet 24, a coolant temperature detection portion 62 that detects the temperature of the coolant, and a temperature control portion 64. The temperature control portion 64 performs a control to increase the temperature of the permanent magnet 24, i.e., a control to restrain increase in the temperature of the permanent magnet 24 according to the temperature of the permanent magnet 24 and the temperature of the coolant. This control can be realized by execution of a software program and, concretely, can be realized by execution of a rotary electric machine drive control program. Alternatively, part of the control may be realized by hardware.

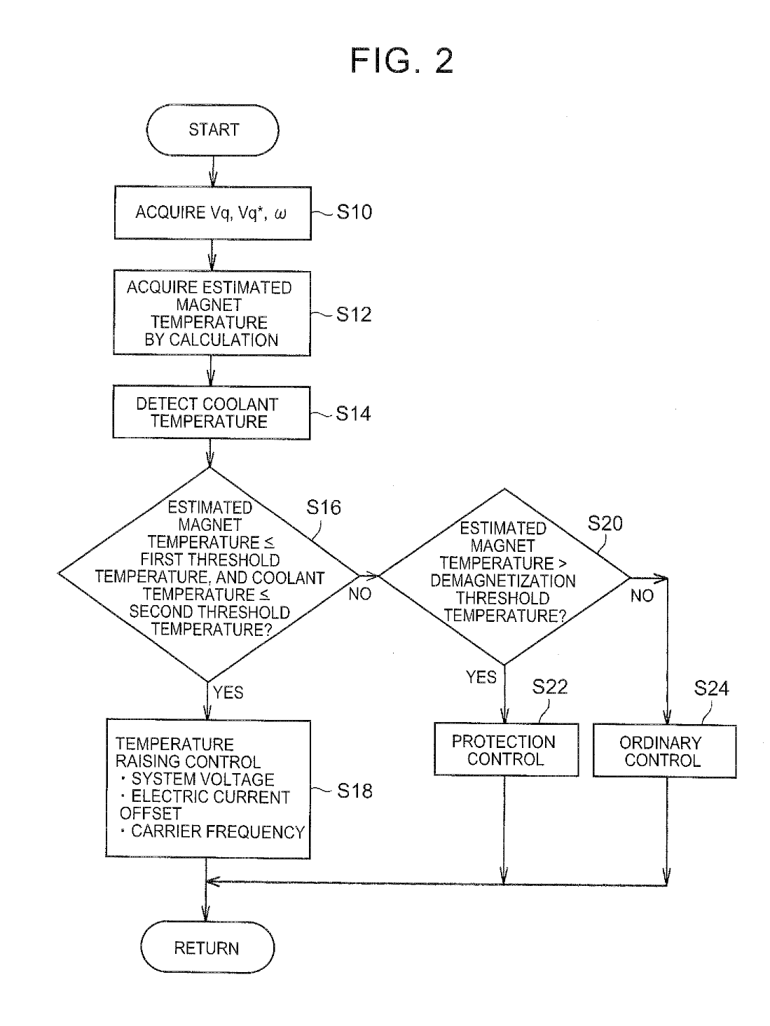

Operation of the foregoing construction will be described in detail with reference to FIGS. 2 to 6B. FIG. 2 is a flowchart showing a procedure of the rotary electric machine drive control to improve the energy efficiency of the vehicle while restraining the demagnetization of the permanent magnet 24. The respective steps shown in FIG. 2 correspond to processing steps of the rotary electric machine drive control program.

In this procedure, the control apparatus 16 acquires the q-axis voltage command value V_{q}*, the q-axis actual voltage value V_{q}, and the rotary angular velocity ω of the rotary electric machine 12 in order to estimate the magnet temperature by, for example, calculation that uses a voltage equation in vector control (S10). The q-axis voltage command value V_{q}* can be acquired from the output of the electric current control portion 50 or the output of the voltage phase control portion 56. The q-axis actual voltage value V_{g} can be obtained by converting the three-phase voltage outputs V_{U}, V_{V} and V_{W} of the inverter 38. The rotary angular velocity ω can be acquired from a value detected by the rotary angular velocity detection portion 28.

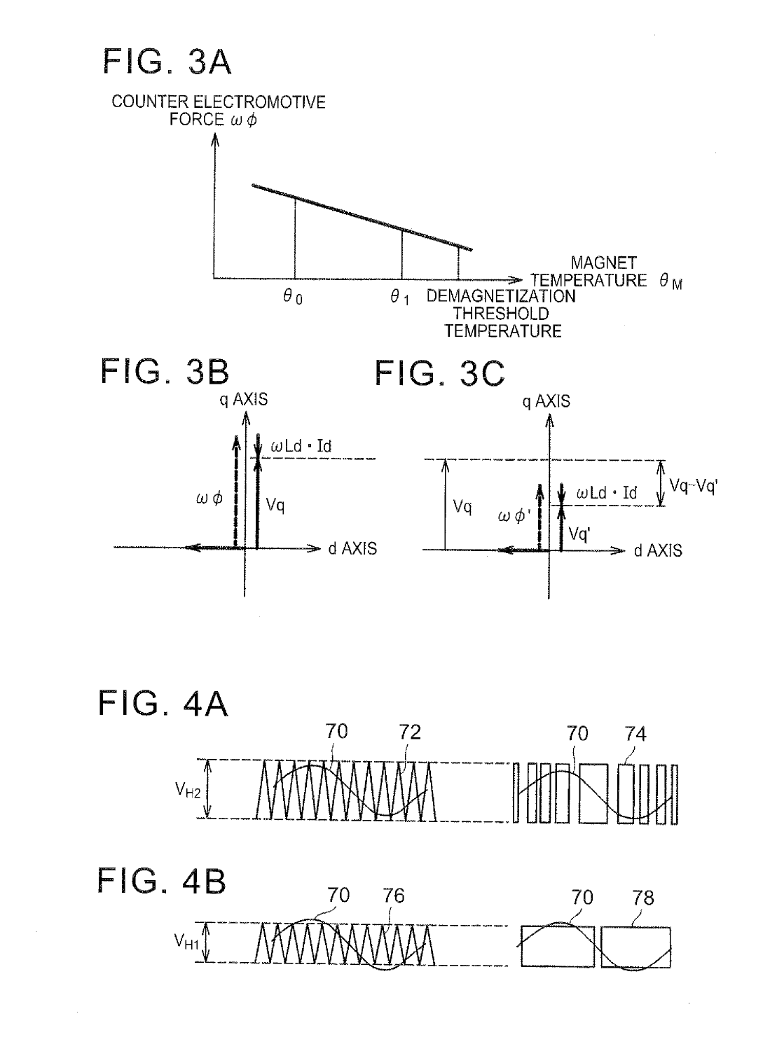

Next, a temperature (a value of temperature) θ_{M} of the permanent magnet 24 is acquired by estimation based on calculation from the acquired values V_{q}*, V_{q} and ω (S12). This processing step is executed by the temperature acquisition portion 60 of the control apparatus 16. Incidentally, the temperature sensor is not used to acquire the temperature θ_{M} of the permanent magnet 24, because the rotary element 20 in which the permanent magnet 24 is buried rotates and therefore it is difficult to draw out a signal line from the temperature sensor. FIGS. 3A to 3C are diagrams showing that a counter electromotive force is calculated from the the q-axis voltage command value V_{q}*, the q-axis actual voltage value V_{q} and the rotary angular velocity ω on the basis of a pre-obtained relational expression of the counter electromotive force and the temperature, and the temperature θ_{M} of the permanent magnet 24 is estimated.

FIG. 3A is a diagram showing a relation between the counter electromotive force and the temperature θ_{M} of the permanent magnet 24. Data that show this relation may be obtained beforehand through an experiment, a simulation, etc. The data that show this relation may be provided in the form of a map, a look-up table, a relational expression, etc. The relation data are stored in an appropriate memory of the control apparatus 16, and are read out when needed.

FIG. 3B is a diagram showing respective components in the vector control at a reference temperature θ₀, and FIG. 3C is a diagram showing respective components in the vector control at an arbitrary temperature θ₁. The reference temperature θ₀ may be a temperature at which the q-axis voltage command value V_{q}* is applied, for example, a normal temperature.

In FIGS. 3B and 3C, V_{q}=ωφ+ωL_{d}I_{d}, the voltage equation in vector control, is used. In this equation, φ is the magnetic flux and L_{d} is the d-axis inductance of the rotary electric machine 12. In FIG. 3B, φ is shown as the magnetic flux at the temperature θ₀. In FIG. 3C, φ′ is shown as the magnetic flux at the temperature θ₁. The factor of demagnetization that occurs as the temperature θ_{M} of the permanent magnet 24 rises from the temperature θ₀ to the temperature θ₁ is {1−(φ′/φ)}. Incidentally, the counter electromotive force is represented by ωφ.

In the diagram of the temperature θ₀ shown in FIG. 3B, the magnetic flux is represented by φ and the q-axis voltage value is represented by V_{q}−V_{q}*. Therefore, FIG. 3B shows a relation of ωφ=V_{q}−ωL_{d}I_{d} since the voltage equation is V_{q}=ωφ+ωL_{d}I_{d} as mentioned above. In the diagram at the temperature θ₁ shown in FIG. 3C, the magnetic flux is φ′ and the q-axis voltage voltage is V_{q}=V_{q}′. In this case, FIG. 3C shows a relation of ωφ′=V_{q}′−ωL_{d}I_{d} since the voltage equation is V_{q}′=ωφ′+ωL_{d}I_{d}.

From comparison between FIG. 3B and FIG. 3C, it can be understood that ω(φ−φ′) can be obtained from (V_{q}−V_{q}′) because ωL_{d}I_{d} is constant despite change in temperature from θ₀ to θ₁. Note that, a change in counter electromotive force is represented by ω(φ−φ′). That is, a change in counter electromotive force due to change in temperature can be obtained by measuring change in the q-axis voltage value. If the change in counter electromotive force is obtained, a temperature change that corresponds to the change in counter electromotive force can be obtained by using the relation shown in FIG. 3A. Thus, the temperature θ_{M} of the permanent magnet 24 can be acquired by estimation based on calculation, without using a temperature sensor. Incidentally, the temperature θ_{M} of the permanent magnet 24 may also be derived by a method other than calculation, for example, referring to a map, or the like.

Referring back to FIG. 2, after the estimated temperature θ_{M} of the permanent magnet 24 is acquired by calculation, a coolant temperature θ_{C} is detected (S14). This processing step is executed by the coolant temperature detection portion 62 of the control apparatus 16. The coolant temperature (value of the coolant temperature) θ_{C} can be acquired by receiving detected data provided by the coolant temperature sensor 32. Incidentally, step S14 may be executed prior to steps S10 and S12.

After the estimated temperature θ_{M} of the permanent magnet 24 and the coolant temperature θ_{C} are acquired, one of a temperature raising control (S18), a protection control (S22) and an ordinary control (S24) is performed according to the temperatures θ_{M} and θ_{C}. These controls are executed by the temperature control portion 64 of the control apparatus 16.

It is determined whether the temperature θ_{M} is less than or equal to a first threshold temperature and the coolant temperature θ_{C} is less than or equal to a second threshold temperature (S16). If an affirmative determination is made in S16, then the temperature raising control in S18 is performed. The temperature raising control is a temperature control that is performed when the temperature θ_{M} is sufficiently low that the raising of the temperature is less likely to result in demagnetization and when the coolant temperature θ_{C} is excessively low that the viscosity of the coolant is high so that the energy efficiency is low.

Therefore, it is appropriate that the first threshold temperature regarding the estimated temperature θ_{M} of the permanent magnet 24 be sufficiently lower than the demagnetization threshold temperature. If the demagnetization threshold temperature is 140° C., it is appropriate that the first threshold temperature be about the service temperature of the rotary electric machine 12. If the service temperature of the rotary electric machine 12 is 75° C., the first threshold temperature may be set to 75° C. Of course, if the first threshold temperature regarding the estimated temperature θ_{M} is sufficiently lower than 140° C., the first threshold temperature may be higher than 75° C., or may instead be lower than 75° C. It is appropriate that a lower limit of the first threshold temperature be greater than or equal to a lower guarantee temperature of the permanent magnet 24. The lower guarantee temperature in the case of a neodymium magnet is, for example, −40° C.

It is appropriate that the second threshold temperature regarding the coolant temperature θ_{C} be the energy efficiency threshold temperature. If the energy efficiency threshold temperature is 50° C., the second threshold temperature is set to 50° C. Of course, since it suffices that the second threshold temperature regarding the coolant temperature θ_{C} is greater than or equal to the energy efficiency threshold temperature, the second threshold temperature may also be greater than or equal to 50° C.

The temperature raising control may include: changing the drive control mode of the rotary electric machine 12 from the square wave control mode to the sine wave control mode by increasing the system voltage V_{H}; providing an offset deviation between the three-phase drive current values of the rotary electric machine 12; and changing the carrier frequency for use in the inverter 38, which is a drive circuit of the rotary electric machine 12, to a lower frequency. These contents of the control will be described later with reference to FIGS. 4A to FIG. 6B.

If a negative determination is made in S16, it is then determined whether the temperature θ_{M} is greater than the demagnetization threshold temperature (S20). In the foregoing example, the demagnetization threshold temperature is 140° C. If an affirmative determination is made in S20, it means that there is possibility of demagnetization of the permanent magnet 24, and therefore the protection control is executed (S22). In the protection control, the system voltage V_{H} is decreased. In the foregoing example, the range of the system voltage V_{H} is from about 500 V to about 600 V.

Therefore, even if the system voltage V_{H} is decreased, the system voltage V_{H} is not less that 500 V in the protection control. This restrains the heat generation caused by operation of the rotary electric machine 12, and decreases the temperature of the permanent magnet 24.

If a negative determination is made in S20, the ordinary rotary electric machine drive control is performed (S24). If a negative determination is made in S16 and a negative detet nination is made in S20 as well, it means that the temperature θ_{M} is greater than or equal to the first threshold temperature and the less than or equal to the demagnetization threshold temperature. In the foregoing example, the temperature θ_{M} is greater than or equal to 75° C. and less than or equal to 140° C. If the temperature θ_{M} and the coolant temperature θ_{C} do not have a considerable difference, the coolant temperature θ_{C} is greater than or equal to the energy efficiency threshold temperature. Therefore, there is no particular need to raise the temperature θ_{M} of the permanent magnet 24 to raise the temperature θ_{C} of the coolant. That is, since demagnetization does not occur and energy efficiency does not decrease, the ordinary rotary electric machine drive control may be continued.

By selectively using the temperature raising control (S18), the protection control (S22) and the ordinary control (S24) in an appropriate manner according to the states of the temperature θ_{M} and the coolant temperature θ_{C} as described above, it is possible to improve energy efficiency while restraining the demagnetization of the permanent magnet 24 and thereby protecting the permanent magnet 24. Furthermore, the temperature adjustment of the coolant and the protection of the permanent magnet 24 can be optimized.

Next, with reference to FIGS. 4A to 6B, a content of the temperature raising control will be described. FIGS. 4A and 4B are diagrams showing that the temperature of the permanent magnet 24 is raised by increasing the system voltage V_{H} and changing the drive control mode of the rotary electric machine 12 from the square wave control mode to the sine wave control mode.

FIG. 4A shows a case where the system voltage V_{H} has been high and the PWM control mode has been entered, and FIG. 4B shows a case where the system voltage V_{H} has been low and the square wave control mode has been entered. In these diagrams, the horizontal axis represents time, and a waveform 70 of the fundamental component in the output of the inverter 38 and waveforms 72 and 76 of the carrier signal are shown in left-side sections of FIGS. 4A and 4B. Furthermore, right-side sections of FIGS. 4A and 4B show the result of comparison between the waveform 70 of the fundamental component and the waveforms 72 and 76 of the carrier signal and conversion of the waveforms 70, 72 and 76 into pulse-forms or square-forms, i.e., pulse conversion or square conversion.

The waveform 70 of the fundamental component in the output of the inverter 38 is a signal waveform obtained when the phase differences between the three-phase drive signals that differ in phase by 120 degrees from each, and is an analog signal waveform prior to performance of the pulse conversion in the PWM circuit 52 or the square conversion in the square wave generation portion 58. The cycle period of this is the rotation period of the rotary electric machine 12. It is to be noted herein that if the system voltage V_{H} is changed, no change is made in the waveform 70 of the fundamental component. That is, the system voltage V_{H} is changed while the operation point of the rotary electric machine 12 is maintained. Specifically, if an affirmative determination is made in S16 in FIG. 2, the system voltage V_{H} is simply changed from V_{H1} to V_{H2}.

When there is no change in the waveform 70 of the fundamental component, there is no change in the absolute value of the voltage command value |V*|−(V_{d}*²+V_{q}*²)^{1/2}. It is to be noted that if the system voltage V_{H} is changed, the modulation factor=|V*|/V_{H} changes. If the system voltage V_{H} is changed from the small value V_{H1} to the large value V_{H2}, the modulation factor decreases. Therefore, the control mode of the rotary electric machine 12 is changed from the square wave control mode to the sine wave control mode. In the example shown in FIGS. 4A and 4B, the control mode is the square wave control mode at the time of the system voltage V_{H1}, and the control mode is changed to the sine wave control mode when the system voltage V_{H} is changed to the large value V_{H2}. For example, at the time of the system voltage V_{H1}=500 V, the modulation factor is 0.78 and the control mode is the square wave control mode. If the modulation factor becomes less than or equal to 0.61 due to change to the system voltage V_{H2}=600 V, the control mode is, automatically changed to the sine wave control mode by the mode switching circuit 46.

Since the inverter 38 is a circuit that outputs drive signals that are supplied to the respective winding wires that produce the rotating magnetic field of the stationary element, the waveform 74 obtained after the pulse conversion and the waveform 78 obtained after the square conversion shown in the right-side sections of FIGS. 4A and 4B show that the rotating magnetic field of the stationary element fluctuates frequently. As shown in FIGS. 4A and 4B, fluctuation of the signal after the pulse conversion in the sine wave control mode occurs more frequently than fluctuation of the signal after the square conversion in the square wave control mode. Thus, at the sine wave control mode, fluctuation of the drive signal is more to the high frequency wave side and fluctuation of the magnetic field of the stationary element is more frequent than at the square wave control mode.

Generally, eddy current loss is proportional to square of a product of the frequency f, the magnetic flux density B and an electromagnetic steel sheet thickness t, that is, (fBt)². If the occurrence frequency of fluctuation of the magnetic field of the stationary element is expressed by f, the occurrence frequency f is larger during the sine wave control mode than during the square wave control mode, so that the eddy current loss of the permanent magnet 24 increases. Therefore, the temperature Oₘ of the permanent magnet 24 rises, and the coolant temperature 9_{c} of the coolant that cools the permanent magnet 24 rises. In this manner, the viscosity of the coolant can be decreased, and the energy efficiency of the vehicle can be improved.

FIGS. 5A to 5C are diagrams showing that the temperature of the permanent magnet 24 is raised by providing an offset deviation between the values of the phase drive electric currents of the rotary electric machine 12. FIG. 5A is a schematic view of the rotary electric machine 12, showing the annular stationary element 18, and the rotary element 20 surrounding by the stationary element 18. The three-phase drive currents I_{U}, I_{V} and I_{W} are supplied to the three-phase winding wires of the stationary element 18. FIG. 5B is a diagram whose horizontal axis represents time, showing a relationship among the three-phase drive currents I_{U}, I_{V} and I_{W} during the ordinary control. As shown in FIG. 5B, the three-phase drive currents are shifted in phase by 120 degree from one another, but have the same signal waveform. Therefore, the control is performed so that the sum of the three-phase drive current values (I_{U}+I_{V}+I_{W}) is zero.

FIG. 5C is a diagram showing an example where the current I_{W} is provided with an offset deviation I_{OFFSET} from the other two currents I_{U} and I_{V}. If an offset deviation is provided between the three-phase drive current values in this manner, the sum of the three-phase drive current values is not zero, so that a DC component current flows. In this case, the operation point of the rotary electric machine 12 does not change but is maintained. The offset deviation can be provided by changing the setting of the bias value of a drive current. Instead, the sensor offset that an electric current sensor for detecting the drive current of each phase is originally provided with may also be utilized. During ordinary control, the sensor offset is made zero in order to secure good electric current detection accuracy. If the control to make the sensor offset zero is not performed, an offset deviation naturally results.

The DC component current produced by the offset deviation accordingly causes fluctuation in the magnetic field of the rotating permanent magnet 24, so that eddy current occurs in the permanent magnet 24. As a result, the permanent magnet 24 rises in temperature, and the coolant that cools the permanent magnet 24 also rises in temperature. In this manner, the viscosity of the coolant can be decreased to improve the energy efficiency of the vehicle.

FIGS. 6A and 6B are diagrams showing that the temperature of the permanent magnet 24 is raised by decreasing the carrier frequency used for the inverter 38, which is a drive circuit of the rotary electric machine 12. The carrier frequency for use in the inverter 38 is the frequency of the waveforms 72 and 76 of the carrier signal described above with reference to FIGS. 4A and 4B.

Each of FIGS. 6A and 6B is a diagram whose horizontal axis represents time, showing a ripple current that is superimposed on the drive current. FIG. 6A shows the case where the carrier frequency is high, and FIG. 6B shows the case where the carrier frequency is low. As shown in FIGS. 6A and 6B, the ripple current superimposed on the drive current increases if the carrier frequency is decreased. Incidentally, despite change in the carrier frequency, the operation point of the rotary electric machine 12 does not change.

If the ripple current increases, the eddy current that occurs in the permanent magnet 24 increases, so that the permanent magnet rises in temperature and therefore the coolant, which cools the permanent magnet, rises in temperature. In this manner, the viscosity of the coolant can be decreased to improve the energy efficiency of the vehicle.

As described above, the changing of the system voltage, the setting of the offset current deviation and the changing of the carrier frequency are preferred examples that allow the operation point of the rotary electric machine to be maintained.

What is claimed is:

1. A control apparatus for a rotary electric machine that has a rotary element that includes a permanent magnet, the control apparatus comprising:
a magnet temperature acquisition portion that acquires information about temperature of the permanent magnet;
a coolant temperature detection portion that detects temperature of a coolant that cools at least the rotary element; and
a temperature control portion that performs a temperature raising control of the permanent magnet when the temperature of the permanent magnet is less than or equal to a first threshold temperature and the temperature of the coolant is less than or equal to a second threshold temperature.

2. The control apparatus according to claim 1, wherein
system voltage of .a drive circuit connected to the rotary electric machine is increased in the temperature raising control, and
a drive control mode of the rotary electric machine is changed from a square wave control mode to a sine wave control mode in the temperature raising control.

3. The control apparatus according to claim 1, wherein
an offset deviation is provided between drive electric current values of phases of the rotary electric machine in the temperature raising control.

4. The control apparatus according to claim 1, wherein
a carrier frequency that is used by a drive circuit connected to the rotary electric machine is changed to a lower carrier frequency in the temperature raising control.

5. The control apparatus according to claim 1, wherein
the temperature control portion performs the temperature raising control while maintaining an operation point of the rotary electric machine.

6. The control apparatus according to claim 1, wherein
the first threshold temperature is lower than a demagnetization threshold temperature at which irreversible demagnetization occurs in the permanent magnet.

7. A rotary electric machine drive system comprising:
a rotary electric machine that has a rotary element that includes a permanent magnet;
a coolant temperature sensor that detects temperature of a coolant that flows in the rotary electric machine;
a control circuit connected to the rotary electric machine; and
a control apparatus that controls the control circuit,
wherein the control apparatus includes a magnet temperature acquisition portion that acquires information about temperature of the permanent magnet, a coolant temperature detection portion that detects the temperature of the coolant, and a temperature control portion, and
wherein the temperature control portion performs a temperature raising control of the permanent magnet when the temperature of the permanent magnet is less than or equal to a first threshold temperature and the temperature of the coolant is less than or equal to a second threshold temperature.

8. A control method for a rotary electric machine that has a rotary element that includes a permanent magnet, the control method comprising:
acquiring information about temperature of the permanent magnet;
detecting temperature of a coolant that cools the rotary element; and
performing a temperature raising control of the permanent magnet when the temperature of the permanent magnet is less than or equal to a first threshold temperature and the temperature of the coolant is less than or equal to a second threshold temperature.

9. The control method according to claim 8, wherein
system voltage of a drive circuit connected to the rotary electric machine is increased in the temperature raising control, and
a drive control mode of the rotary electric machine is changed from a square wave control mode to a sine wave control mode in the temperature raising control.

10. The control method according to claim 8, wherein
an offset deviation is provided between drive electric current values of phases of the rotary electric machine in the temperature raising control.

11. The control method according to claim 8, wherein
a carrier frequency that is used by a drive circuit connected to the rotary electric machine is changed to a lower carrier frequency in the temperature raising control.

12. The control method according to claim 8, wherein
the temperature raising control is performed while an operation point of the rotary electric machine is maintained.

13. The control method according to claim 8, wherein
the first threshold temperature is lower than a demagnetization threshold temperature at which irreversible demagnetization occurs in the permanent magnet.
